(19) United States
(12) Patent Application Publication
(10) Pub. No.: US 2021/0268457 A1
(43) Pub. Date: Sep. 2, 2021

(54) Adapter With Integral Mixer Element

(71) Applicant: NORDSON CORPORATION, WESTLAKE, OH (US)

(72) Inventor: Matthew E. Pappalardo, Robbinsville, NJ (US)

(21) Appl. No.: 17/258,243

(22) PCT Filed: Jul. 3, 2019
(86) PCT No.: PCT/US2019/040596

§ 371 Date: Jan. 6, 2021

Related U.S. Application Data
(60) Provisional application No. 62/700,299, filed on Jul. 18, 2018.

(51) Int. Cl. B01F 13/00; B01F 15/00

(52) U.S. Cl. CPC B01F 13/0023; B01F 2005/0008; B01F 15/0087; B01F 15/0048

(57) ABSTRACT

An adapter couples to a container and includes an adapter body and a mixing element. The adapter body includes a neck section and a cap section. The neck section has a first interior surface that defines a first channel extending therethrough. The cap section is coupled to the neck section. The cap section has a second interior surface that defines a second channel extending therethrough that is in fluid communication with the first channel. The mixing element is coupled to the first interior surface and extends into the first channel.

### CROSS REFERENCE TO RELATED APPLICATIONS

This application is a National Stage Application of International Patent App. No. PCT/US2019/040596, filed Jul. 3, 2019 which claims the benefit of U.S. Provisional Patent App. No. 62/700,299, filed Jul. 18, 2018, the entire disclosures of both of which are hereby incorporated by reference as if set forth in their entirety herein.

### TECHNICAL FIELD

This disclosure relates generally to a fluid dispensing system, and more particularly to a fluid dispensing system having an adapter with an integral mixer element.

### BACKGROUND

Dispensing systems are commonly used for dispensing one or more fluids from containers. For example, some dispensing systems use so-called “sausage pack” containers, which are flexible and collapsible fluid containers. This type of collapsible container is generally cylinder shaped, and includes a fluid enclosed by a flexible membrane. Collapsible containers are generally sealed until they are ready to be used, at which point it is necessary to puncture the membrane. As the fluid is extracted from the container, the membrane may collapse to occupy a smaller volume than when it was full.

In one current system, two component adhesives and other reactive materials are contained and transported in solid plastic side-by-side two component cartridges. In other systems, the two component materials are transported in separate sausage pack containers. The materials must be dispensed by a side-by-side dual chambered dispenser and be connected and dispensed out of a two inlet adapter upon which a mixer may be attached.

In another current system, the two materials are packaged together in a single sausage pack, which includes a pack inside of a pack. These single sausage packs containing two separate materials have an advantage over separated sausage packs because they can be dispensed out of a standard single component sausage pack dispenser. Mixers may be attached to the single component dispenser to mix together the two components as they are being dispensed. The mixers are subject to a streaking phenomenon, which is a tendency to leave streaks of completely unmixed fluid in the extruded mixture.

Thus, an improved and/or simplified dispensing system for dispensing two materials from a single sausage pack is desired to more effectively mix the components during dispensing.

### SUMMARY

The present disclosure provides an improved dispensing system that includes an adapter for use with a single component dispenser to mix two materials being dispensed from a single sausage pack. The adapter assembly is configured to attach to the single component dispenser and to a mixer.

An aspect of the present disclosure provides an adapter. The adapter comprises an adapter body and a mixing element. The adapter body is configured to couple to a fluid container and includes a neck section and a cap section. The neck section has a first interior surface that defines a first channel extending therethrough. The neck section also has an exterior surface being adapted for receiving a nozzle. The cap section is coupled to the neck section, and has a second interior surface that defines a second channel extending therethrough. The second channel is in fluid communication with the first channel. The mixing element is coupled to the first interior surface and extends into the first channel. The mixing element can be integrally formed with the neck section of the adapter body such that the mixing element and the adapter body form a single integrally formed component.

In another aspect of the present disclosure, the adapter is configured to couple to a fluid container. The neck section of the adapter body further has an exterior surface that defines a first attachment portion. The adapter assembly further comprising a nozzle that includes a second attachment portion configured to engage with the first attachment portion of the neck section to secure the nozzle to the adapter body.

Another aspect of the present disclosure provides a dispenser, such as a single component dispenser. The single component dispenser includes a fluid container, an adapter having a mixing element, and a nozzle. The adapter is configured to couple to the fluid container. The adapter includes a neck section and a cap section. The neck section has an exterior surface and a neck interior surface. The neck interior surface defines a neck channel that extends therethrough. The cap section is coupled to the neck section. The cap section has a cap interior surface that defines a cap channel that extends therethrough. The cap channel is in fluid communication with the neck channel. The mixing element is coupled to the neck interior surface and extends into the neck channel. The nozzle includes a second threaded portion configured to engage with the first threaded portion of the neck section to secure the nozzle to the adapter body.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown. In the drawings:

FIG. 1A illustrates a perspective view of a fluid dispenser.

FIG. 1B illustrates an exploded perspective view of the fluid dispenser illustrated in FIG. 1A.

FIGS. 2A and 2B illustrate a front perspective view and a back perspective view of a first aspect of an adapter assembly.

FIGS. 3A and 3B illustrate a front perspective view and a back perspective view of a second aspect of an adapter assembly.

FIGS. 4A and 4B illustrate a front perspective view and a back perspective view of a third aspect of an adapter assembly.

FIGS. 5A and 5B illustrate a front perspective view and a back perspective view of a fourth aspect of an adapter assembly.

FIGS. 6A and 6B illustrate a front perspective view and a back perspective view of a fifth aspect of an adapter assembly.

FIGS. 7A and 7B illustrate a front perspective view and a back perspective view of a sixth aspect of an adapter assembly.

FIGS. 8A and 8B illustrate a front perspective view and a back perspective of a seventh aspect of an adapter assembly.

### DETAILED DESCRIPTION

The disclosure relates generally to a single component fluid dispenser for dispensing two fluids from a single collapsible container (e.g. bag-in-bag 2k pack). The fluid dispensing system includes a container and an adapter (e.g. manifold) that has a mixer element integrally molded within. The adapter is configured to couple to a distal end of the container such that when the two fluids are being dispensed out of the container they are mixed within the adapter by the mixer element as the flow therethrough. A nozzle may be coupled to a distal end of the adapter to further mix the two fluids as they are dispensed.

Certain terminology is used in the description for convenience only and is not limiting. The words “proximal” and “distal” generally refer to positions or directions toward and away from, respectively, an individual operating a fluid dispenser 100. The words “longitudinal”, “radial,” and “transverse” designate directions in the drawings to which reference is made. The term “substantially” is intended to mean considerable in extent or largely but not necessarily wholly that which is specified. The terminology includes the above-listed words, derivatives thereof and words of similar import.

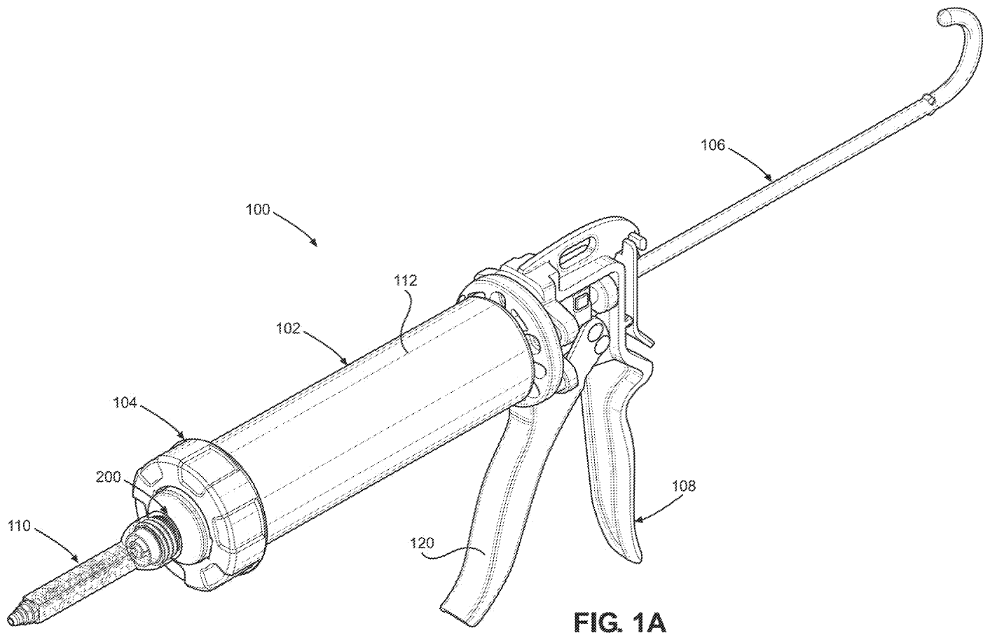

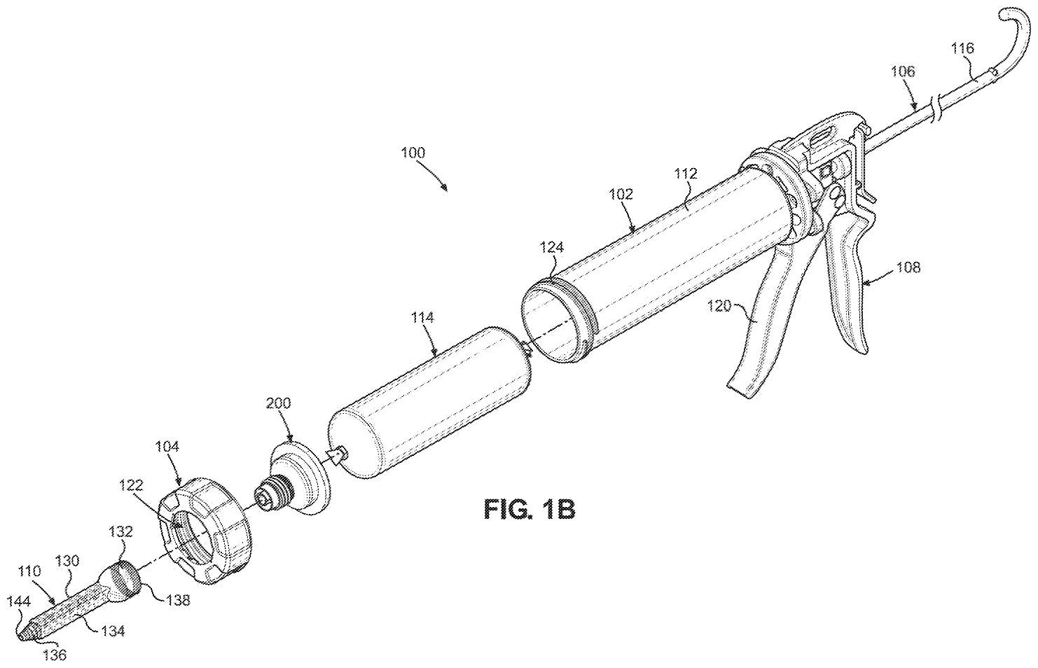

FIGS. 1A and 1B illustrates a collapsed perspective view and an exploded perspective view of the fluid dispenser 100, respectively, according, to aspects of this disclosure. The fluid dispenser 100 includes a container 102, a nut 104, a plunger assembly 106, an actuator 108, a mixer 110 (e.g., nozzle), and an adapter assembly 200. The container 102 includes a cylindrical barrel 112. The containers 102 may include ribs (not shown) and/or optional retention ribs (not shown) that extend along an outer surface from a distal end to a proximal end of the container 102. In an aspect, the container 102 may be configured to be supported by and fit within a support structure (not shown), such that the ribs support the container within the support structure.

The container 102 is configured to hold a collapsible container 114 within. As used herein, the term “collapsible container” refers to the type of flexible and collapsible fluid containers which are known in the art as “sausage packs.” It will also be appreciated that the collapsible container 114 is also applicable to other types of rigid or flexible containers that have a pierceable component that must be pierced before fluid can be dispensed from the container. The container 102 may include barrels having varying site diameters, for example, based on varying sizes of collapsible containers 114.

The collapsible container 114 may include a flexible and collapsible, yet resilient, membrane. The membrane is configured to be pierced in order to provide access to the material contained within the membrane. The collapsible containers are generally cylindrical in shape and have a diameter and length slightly less than the container 102. The collapsible container 114 is a bag-in-bag container configured to hold two materials (e.g. fluids). Each bag within the collapsible container 114 may have a volume similar to a volume of the other bag, or alternatively, the volume of each bag may be different. The volume of each bag within the collapsible container 114 may depend on the types of fluids being dispensed. In some embodiments, the bags may be adjacent to one another in a side-by-side configuration.

The plunger assembly 106 may include a plunger (not visible in figures) and a thrust rod 116. The plunger is configured to slide within the cylindrical barrel 112. The plunger is coupled to a distal end of the corresponding thrust rod 116. The thrust rod 116 extends from a proximal end of the fluid dispenser 100 into the cylindrical barrel 112.

The actuator 108 acts to effect concurrent movement of the thrust rod 116 to advance or retract the plunger. The actuator 108 may be operatively coupled to the thrust rod 116 of the plunger assembly 106, such that actuation of a trigger 120 of the actuator 108 advances the thrust rod 116 in the distal direction. The advancement of the thrust rod 116 causes the plunger to advance into the cylindrical barrel 112. The actuator 108 may comprise a manually driven gun, as shown in the figures, a pneumatically driven gun, or other actuation mechanism configured to drive the plunger.

In an aspect, the fluid dispenser 100 may further include a support structure (not shown). The support structure may include various components, for example, a base, extension arms, and a gate. The support structure is configured to support the container 102 within the fluid dispenser 100.

The nut 104 is configured to secure the adapter assembly 200 to the container 102. The nut 104 includes a cylindrical inner surface that defines an inner threaded section 122 thereon, and a channel that extends through the nut 104. The inner threaded section 122 is configured to engage with an outer threaded section 124 on a distal end of the container 102. The adapter assembly 200 is sized to fit at least partially within the channel of the nut 104 as further described herein.

The mixer 110 includes a body 130 having a flared base 132, a conduit or passage 134, and a tapered dispensing tip 136. The base 132 is configured to engage and attach to the adapter assembly 200. The base 132 includes an inlet 138 and an internal attachment portion (e.g. threaded portion), which is not visible in figures. The conduit 134 includes an internal passageway (not visible in figures) that is in fluid communication with the inlet 138. The conduit 134 includes a mixing element (not visible in figures) positioned within the internal passageway. The mixing element may include various types of mixing elements as further described below. The dispensing tip 136 includes an outlet 144 that is in fluid communication with the internal passageway of the conduit 134.

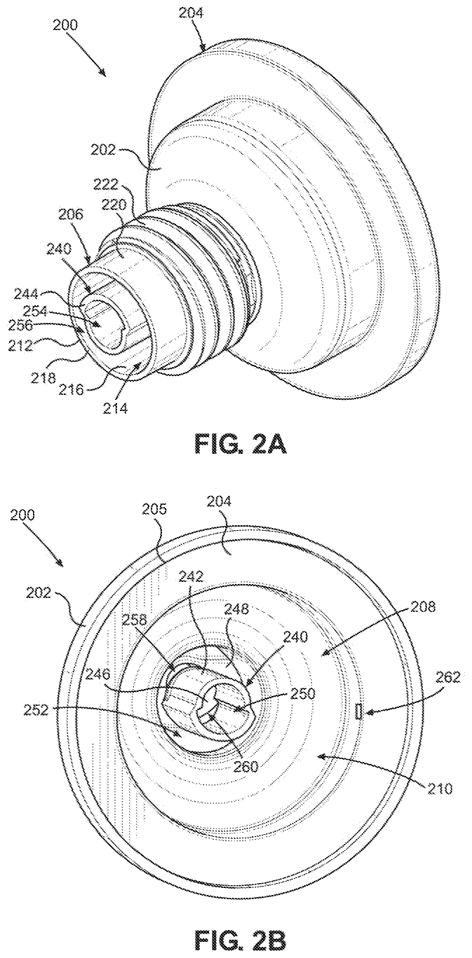

FIGS. 2A and 2B illustrate a front perspective view and a back perspective view of the adapter assembly 200, respectively, according to aspects of this disclosure. The adapter assembly 200 includes a body 202 that has a cap section 204 and a neck section 206. The cap section 206 has a generally tubular shape and is configured to receive a portion of the collapsible container 114 within. A distal end of the collapsible container 114 may be positioned within an opening 205 of the cap section. In an aspect, the collapsible container 114 may be adhesively coupled to the adapter assembly 200.

The cap section 204 includes an interior surface 208 that defines a cap channel 210 that extends through the cap section 204 from the opening 205 to the neck section 206. The cap channel 210 may have a cylindrical shape, tapered shape, combinations thereof, or still other shape.

The neck section 206 of the adapter assembly 200 is positioned substantially centrally with respect to the cap section 204, and extends away therefrom to a distal end 212. The neck section 206 includes a neck channel 214 (e.g. bore) defined by an interior surface 216 of the neck section 206. The neck channel 214 extends from the cap channel 210 to an opening 218 at the distal end 212.

The neck section 206 includes an exterior surface 220 that defines an attachment portion 222 (e.g. threaded portion). In an aspect, the threaded portion 222 is adjacent to the distal end 212 of the adapter assembly 200. The threaded portion 222 is configured to engage with the internal threaded portion of the mixer 110 to secure the mixer 110 to the adapter assembly 200.

The adapter assembly 200 further includes a mixing element 240 (e.g. inversion mixer) positioned at least partially within the neck section 206 of the adapter assembly 200. In an alternative aspect, the mixing element 240 may also extend into the cap channel 210 of the cap section 204, and/or may extend through the opening 218 at the distal end 212 of the adapter assembly 200. The mixing element 240 is coupled to the interior surface 216 of the neck section 206 and extends into the neck channel 214. The mixing element 240 may include, for example, fins, wedges, webs, plates, bars, baffles, combinations thereof, or other mixing elements.

In an aspect, the mixing element 240 is integrally formed with the neck section 206 such that the neck section 206 and the mixing element 240 form a single component. In another aspect, the cap section 204, the neck section 206, and the mixing element 240 are integrally formed together creating a single integrally formed adapter assembly 200. In another aspect, adapter assembly 200 is integrally formed with the nut 104 to form a single integrally formed adapter assembly 200 that may be directly coupled to the container 102.

The integral formation of the mixing element 240 and the neck section 206 provides several advantages that include, for example, mixing fluids having different viscosities and/or component ratios and reducing the likelihood of streaks that form in mixtures dispensed through traditional adapter assemblies. Additionally, mixing fluids within the adapter assembly 200 allows a user to choose a mixer 110 that requires fewer mixing elements which results in a smaller retained volume within (e.g. shorter in length or smaller diameter) or higher flow rate to be used depending on the material. With an inversion mixing element, a mixer length may be reduced significantly, resulting in approximately 30% less retained waste.

The mixing element 240 includes a lower partition wall 242, an upper partition wall 244, an inner divider wall 246, and an outer divider wall 248. The lower partition wall 242 extends from a proximal end of the mixing element 240 to the inner divider wall 246 and the outer divider wall 248. The inner divider wall 246 extends from an inner surface of the lower partition wall 242, and the outer divider wall 248 extends from an outer surface of the lower partition wall 242 to the interior surface 216 of the neck section 206. The upper partition wall 244 extends from a distal end of the mixing element 240 to the inner divider wall 246 and the outer divider wall 248. The inner divider wall 246 extends from an inner surface of the upper partition wall 244, and the outer divider wall 248 extends from an outer surface of the upper partition wall 244 to the interior surface 216 of the neck section 206. The outer divided wall 248 secures the mixing element 240 to the neck section 206.

The inner surface of the lower partition wall 242 defines an inner opening 250 at the proximal end of the neck section 206, and the outer surface of the lower partition wall 242 and the interior surface 216 of the neck section 206 define an outer opening 252 at the proximal end of the neck section 206. The outer opening 252 at the proximal end extends circumferentially about the inner opening 250 at the proximal end. The inner surface of the upper partition wall 244 defines an inner opening 254 at a distal end of the neck section 206, and the outer surface of the upper partition wall 244 and the interior surface 216 of the neck section 206 define an outer opening 256 at the distal end of the neck section 206. The outer opening 256 at the distal end extends circumferentially about the inner opening 254 at the distal end. The outer divider wall 248 and the inner divider wall 246 define a central outer opening 258 and a central inner opening 260 therebetween. The inner opening 250 at the proximal end is in fluid communication with the outer opening 256 at the distal end via the central inner opening 260, and the outer opening 252 at the proximal end is in fluid communication with the inner opening 254 at the distal end via the central outer opening 258. The alignment of the openings is such that fluid flow through the outer opening 252 at the proximal end to the inner opening 254 at the distal end is a perimeter-to-center flow, and fluid flow through the inner opening 250 at the proximal end to the outer opening 256 at the distal end is a center-to-perimeter flow. It will be appreciated that the adapter assembly 200 may include various configurations of mixing elements as further described herein.

The adapter assembly 200 may also include a position indicator 262 integrally molded onto the cap section 204. The position indicator 262 is configured to align the body 202 of the adapter assembly 200 with the container 102 and/or with the collapsible container 114. The position indicator 262 may include a recess, a protrusion, or other configuration that aligns with a corresponding recess, protrusion, or other configuration on the container 102 and/or collapsible container 114.

The adapter assembly 200 may also include a piercing member (not shown). The piercing member may be coupled to the body 202 of the adapter assembly 200. The piercing member extends into the cap channel 210 of the cap section 204, such that when a collapsible container is positioned within the cap channel 210, the piercing member may engage and pierce the membrane of the container.

In an alternate aspect, the adapter assembly 200 may include multiple piercing members or at least two piercing members (not shown). For example, for a bag-in-bag collapsible container, the adapter assembly 200 may include two piercing members, one piercing member for each bag of the collapsible container.

The use of the fluid dispenser 100 is now described. The fluid dispenser 100 may he provided in a partially disassembled state. For example, the fluid dispenser 100 may be provided with the actuator 108, the plunger assembly 106, and the support structure coupled together, but without the containers 102, nut 104, mixer 110, and adapter assembly 200 coupled thereto. Further, the adapter assembly 200 may not be provided coupled to the containers 102. Additionally, a protective cap (not shown) may be provided to cover the piercing member within the adapter assembly 200. The protective cap may protect the piercing member so that they are not damaged so that, for example, the adapter assembly 200 can be safely sold and transported without concern that the piercing member would damage or be damaged by other components.

When it is desirable to pierce the membranes of the collapsible container 114, the protective cap may be removed from the adapter assembly 200. The collapsible container 114 may be positioned within the container 102, and the adapter assembly 200 may be positioned at a distal end of the container 102. The piercing member may pierce the collapsible container 114 within the container 102. The collapsible container 114 may be provided already glued into position with the adapter 200. Alternatively, the collapsible container 114 may be pierced by a blade, needle, or other sharp object, either before or after being positioned within the container 102. The adapter assembly 200 is secured to a distal end of the cylindrical barrel 112 by the nut 104. To align the adapter assembly 200 with the cylindrical barrel 112, the position indicator 262 aligns with a corresponding feature on the cylindrical barrel 112. The alignment of the adapter assembly 200 with the cylindrical barrel 112 enables the fluids within the cylindrical barrel 112 to be aligned with the appropriate openings/channels within the adapter assembly 200. The inner threaded section 122 of the nut 104 engages with the outer threaded section 124 of the container 102, securing the nut 104 to the container 102. The nut 104 defines an opening through which the neck section 206 of the adapter assembly 200 extends.

The mixer 110 is coupled to the neck section 206 of the adapter assembly 200, such that the internal threaded portion of the base 132 of the mixer 110 engages with the threaded portion 222 of the neck section 206. The container 102 may then be positioned within the support structure, or the container 102 may be directly coupled to the plunger assembly 106. The collapsible container 114 is secured within the container 102 between the adapter assembly 200 and the plunger assembly 106.

The actuator 108 is configured to provide a force to the plunger assembly 106 moving the thrust rod 116 in the distal direction forcing the collapsible container 114 to engage the adapter assembly 200. Since the collapsible container 114 is pierced, the fluids contained within the collapsible container 114 can be extracted to flow through the adapter assembly 200 as the force from the thrust rod 116 is applied to the collapsible container 114. In particular, a first fluid within the collapsible container 114 flows through the adapter assembly 200 from the inner opening 250 to the outer opening 256 at the distal end, and a second fluid within the collapsible container 114 flows through the adapter assembly 200 from the outer opening 252 to the inner opening 254 at the distal end.

After the fluids exit the adapter assembly 200 at the distal end 212, the fluids are introduced into the mixer 110 through the inlet 138 of the base 132. The fluids may be further mixed as they flow through the internal passageway of the conduit 134. The conduit 134 may include various mixing elements in the internal passageway, for mixing the two fluids in the mixer 110.

The outlet 144 of the dispensing tip 136 communicates with the internal passageway of the conduit 134. A composite fluid formed by the mixture of the two fluids created in the adapter assembly 200 and the mixer 110 flow through the outlet 144 to a point application. Thus, the two fluids from the collapsible container 114 may be discharged from the outlet 144.

While the present aspect has been described in the context of a fluid dispenser 100 having a single collapsible container 114, it will be appreciated that the fluid dispenser 100 may be configured to have multiple collapsible containers each containing fluids to be mixed within the adapter assembly 200 and/or the mixer 110. Regardless of the number of containers, the adapter assembly 200 is configured to include a mixing element 240 within the neck section 206, and further configured to be coupled with one or more containers. The adapter assembly 200 is configured to be attached to the mixer 110 and may include one or more cap sections 204 for receiving one or more collapsible containers.

Although reference is made to the fluid dispenser 100 having the adapter assembly 200 with the mixing element 240 in the above described example, it will be appreciated that this method may also be employed by alternative aspects of the fluid dispenser 100 having aspects of the adapter assembly 200 with various embodiments of mixing elements as further described below.

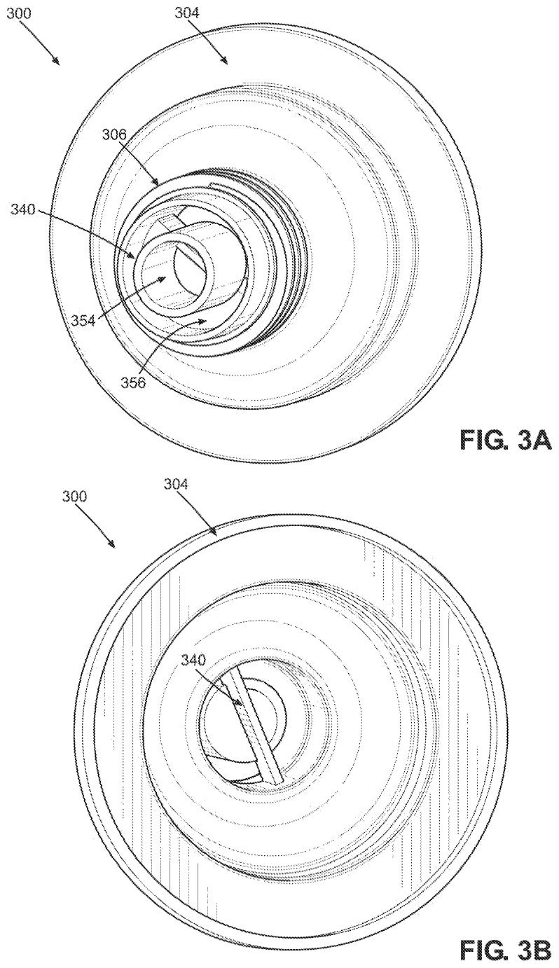

FIGS. 3A and 3B illustrate a front perspective view and a back perspective view of an alternative aspect of an adapter assembly 300, respectively. The adapter assembly 300 includes a cap section 304 and a neck section 306 configured substantially similarly to the cap section 204 and a neck section 206 of the adapter assembly 200. The adapter assembly 300 includes a mixing element 340 (e.g. center of flow redirect mixer) positioned at least partially within the neck section 306. The mixing element 340 may be positioned within the adapter assembly 300 and integrally formed with the neck section 306 substantially to the mixing element 240 within the adapter assembly 200 as described above. The mixing element 340 may be secured to the container 102 and the mixer 110 may be secured to the mixing element 340 substantially similarly as the mixing element 240 is secured to the container 102 and the mixer 110 as describe above.

The adapter assembly 300 is configured to receive two fluids within the neck section 306 side-by-side. As the two fluid flow through the neck section 306 and through the mixing element 340, one fluid exits the adapter assembly 300 through an inner opening 354, and the other fluid exits the adapter assembly 300 through an outer opening 356. The mixing element 340 forming a composite fluid by the mixture of the two fluids in the adapter assembly 300 that includes one fluid in a center with the other fluid around a perimeter.

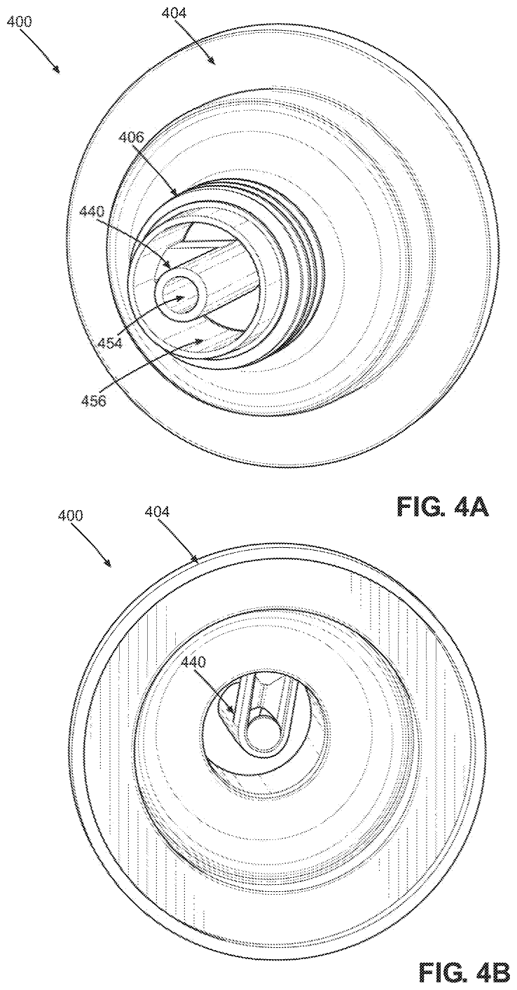

FIGS. 4A and 4B illustrate a front perspective view and a back perspective view of another alternative aspect of an adapter assembly 400, respectively. The adapter assembly 400 includes a cap section 404 and a neck section 406 configured substantially similarly to the cap section 204 and a neck section 206 of the adapter assembly 200. The adapter assembly 400 includes a mixing element 440 (e.g. center of flow redirect mixer) positioned at least partially within the neck section 406. The mixing element 440 may be positioned within the adapter assembly 400 and integrally formed with the neck section 406 substantially similarly to the mixing element 240 within the adapter assembly 200 as described above. The mixing element 440 may be secured to the container 102 and the mixer 110 may be secured to the mixing element 440 substantially similarly as the mixing element 240 is secured to the container 102 and the mixer 110 as describe above.

The adapter assembly 400 is configured to receive two fluids within the neck section 406. As the two fluid flow through the neck section 406 and through the mixing element 440, one fluid exits the adapter assembly 400 through an inner opening 454, and the other fluid exits the adapter assembly 400 through an outer opening 456. The mixing element 440 is configured to form a composite fluid by the mixture of the two fluids flowing through the adapter assembly 400 that includes one fluid in a center with the other fluid around a perimeter.

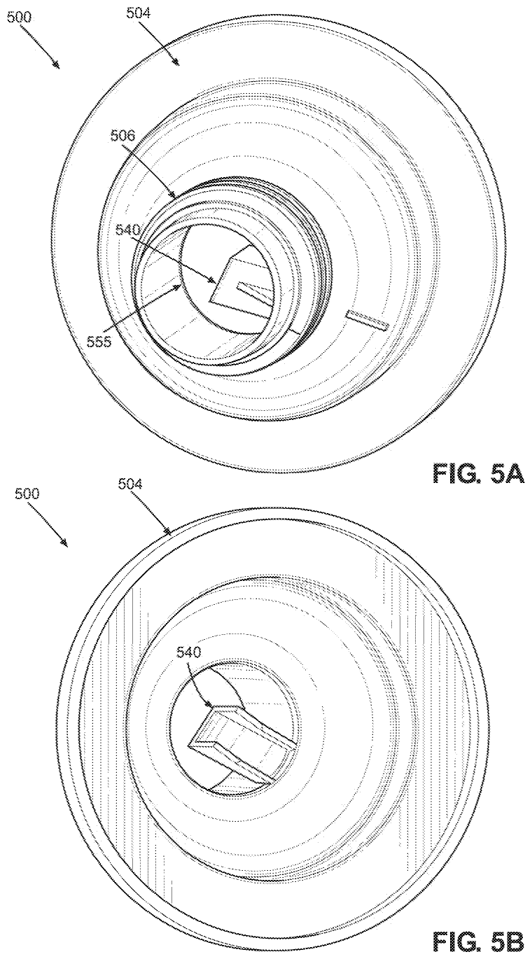

FIGS. 5A and 5B illustrate a front perspective view and a back perspective view of another alternative aspect of an adapter assembly 500, respectively. The adapter assembly 500 includes a cap section 504 and a neck section 506 configured substantially similarly to the cap section 204 and a neck section 206 of the adapter assembly 200. The adapter assembly 500 includes a mixing element 540 (e.g. center of flow redirect mixer) positioned at least partially within the neck section 506. The mixing element 540 may be positioned within the adapter assembly 500 and integrally formed with the neck section 506 substantially similarly to the mixing element 240 within the adapter assembly 200 as described above. The mixing element 540 may be secured to the container 102 and the mixer 110 may be secured to the mixing element 540 substantially similarly as the mixing element 240 is secured to the container 102 and the mixer 110 as describe above.

The adapter assembly 500 is configured to receive two fluids within the neck section 506. After the two fluid flow through the neck section 506 and through the mixing element 540, both fluids exit the adapter assembly 500 through an opening 555. The mixing element 540 is configured to form a composite fluid by the mixture of the two fluids flowing through the adapter assembly 500 that includes shifting one section of the fluid from the perimeter to the center of the fluid flow.

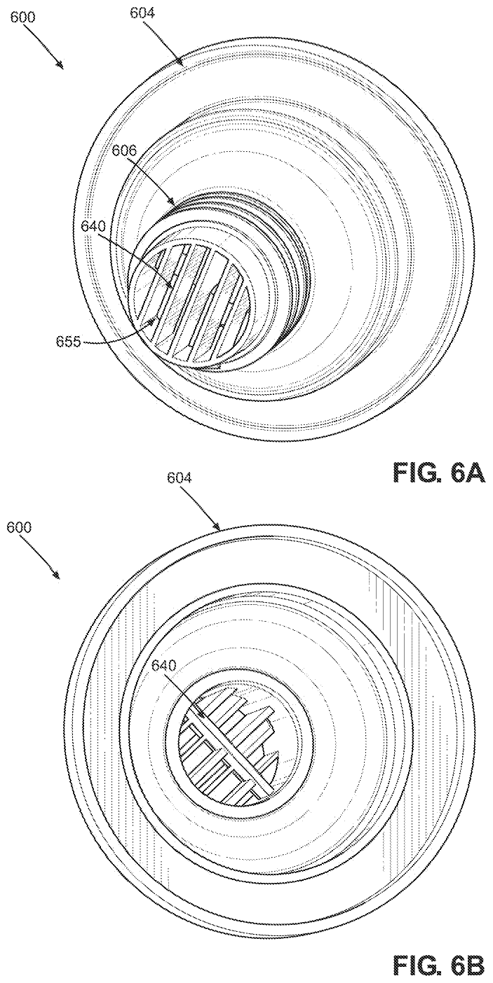

FIGS. 6A and 6B illustrate a front perspective view and a back perspective view of another alternative aspect of an adapter assembly 600, respectively. The adapter assembly 600 includes a cap section 604 and a neck section 606 configured substantially similarly to the cap section 204 and a neck section 206 of the adapter assembly 200. The adapter assembly 600 includes a mixing element 640 (e.g. multiflux mixer) positioned at least partially within the neck section 606. The mixing element 640 may be positioned within the adapter assembly 600 and integrally formed with the neck section 606 substantially similarly to the mixing element 240 within the adapter assembly 200 as described above. The mixing element 640 may be secured to the container 102 and the mixer 110 may be secured to the mixing element 640 substantially similarly as the mixing element 240 is secured to the container 102 and the mixer 110 as describe above.

The adapter assembly 600 is configured to receive two fluids within the neck section 606 side-by-side. As the two fluids flow through the neck section 606 and through the mixing element 640, each fluid is stacked one on top of the other forming multiple layers of the two fluids as they exit the adapter assembly 600 through an opening 655.

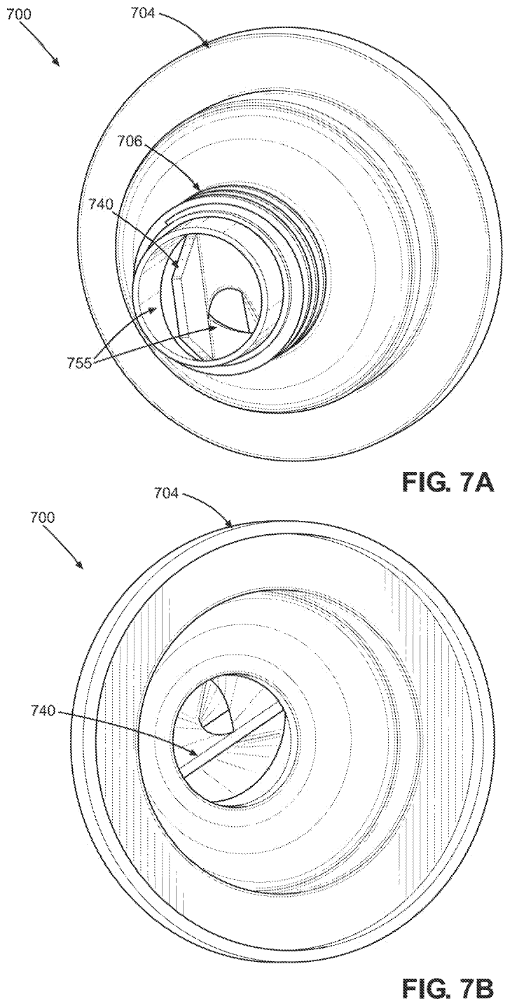

FIGS. 7A and 7B illustrate a front perspective view and a back perspective view of another alternative aspect of an adapter assembly 700, respectively. The adapter assembly 700 includes a cap section 704 and a neck section 706 configured substantially similarly to the cap section 204 and a neck section 206 of the adapter assembly 200. The adapter assembly 700 includes a mixing element 740 (e.g. spiral mixer) positioned at least partially within the neck section 706. The mixing element 740 may be positioned within the adapter assembly 700 and integrally formed with the neck section 706 substantially similarly to the mixing element 240 within the adapter assembly 200 as described above. The mixing element. 740 may be secured to the container 102 and the mixer 110 may be secured to the mixing element 740 substantially similarly as the mixing element 240 is secured to the container 102 and the mixer 110 as describe above.

The adapter assembly 700 is configured to receive two fluids within the neck section 706 side-by-side. As the two fluids flow through the neck section 706 and through the mixing element 740, each fluid spirals around a central axis. The mixing element 740 is configured to form a composite fluid with the two fluids spiraled about each other thus forming multiple layers of materials as they exit the adapter assembly 700 through an opening 755.

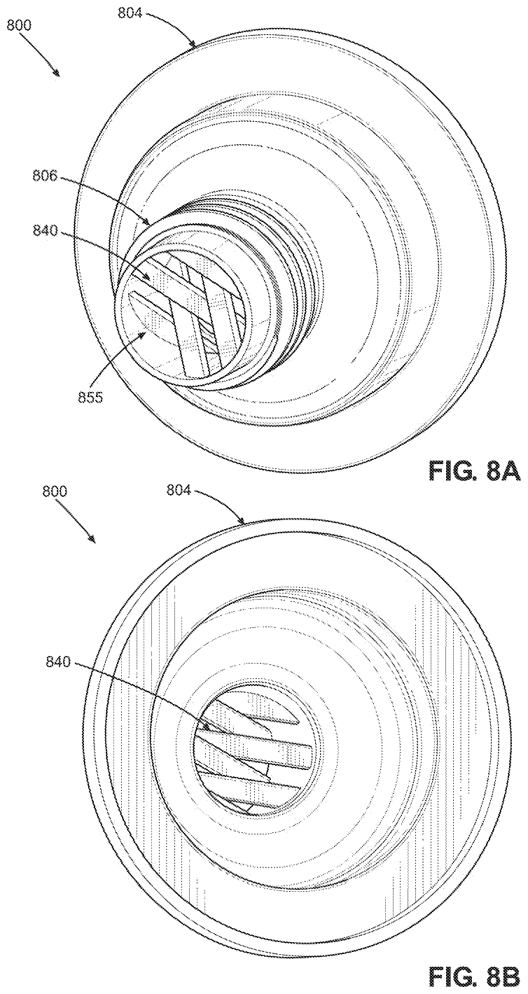

FIGS. 8A and 8B illustrate a front perspective view and a back perspective view of another alternative aspect of an adapter assembly 800, respectively. The adapter assembly 700 includes a cap section 804 and a neck section 806 configured substantially similarly to the cap section 204 and a neck section 206 of the adapter assembly 200. The adapter assembly 800 includes a mixing element 840 (e.g. x-mixer) positioned at least partially within the neck section 806. The mixing element 840 may be positioned within the adapter assembly 800 and integrally formed with the neck section 806 substantially similarly to the mixing element 240 within the adapter assembly 200 as described above. The mixing element 840 may be secured to the container 102 and the mixer 110 may be secured to the mixing element 840 substantially similarly as the mixing element 240 is secured to the container 102 and the mixer 110 as describe above.

The adapter assembly 800 is configured to receive two fluids within the neck section 806. As the two fluids flow through the neck section 806 and through the mixing element 840, each fluid is mixed with the other forming as they exit the adapter assembly 800 through an opening 855.

The mixer 110 may also include a mixer element (not shown) configured to mix two fluids as they flow through the internal passageway of the conduit 134. The mixer element of the mixer 110 may be substantially the same as the mixer element positioned within the adapter assembly to which the mixer 110 is attached, or alternatively, the mixer 110 may have a mixer element that is different from the mixer element positioned within the adapter assembly. In addition, other mixers could also be used and coupled to the adapter assembly, such as mixers that do not include mixing elements.

The fluid dispenser 100 may be used with various types of collapsible containers. For example, containers that have a pierceable component that must be pierced before fluid can be dispensed from the container (such as syringes, for example) can be used with the adapter assembly 200 in a manner consistent with the above.

Further, in some cases a fluid dispensing assembly, such as the fluid dispenser 100 described above, may be suitable for a single use and will be discarded thereafter, or when its associated collapsible container is empty. In other cases, however, the fluid dispenser 100 may include a mixer and an adapter that are reused with different collapsible containers. For example, after a collapsible container used with a fluid dispensing assembly has been emptied of its fluid contents, it may be removed from the adapter assembly and be replaced by a full collapsible container. As part of replacing the collapsible container, the adapter assembly would be removed from the container so that once a full collapsible container could be placed within the container.

It will be appreciated that the foregoing description provides examples of the disclosed system and method. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

What is claimed is:

1. An adapter configured to couple to a fluid container, the adapter comprising:
a neck section having a first interior surface and an exterior surface, the first interior surface defining a first channel extending therethrough, the exterior surface being adapted for receiving a nozzle;
a cap section coupled to the neck section, the cap section having a second interior surface that defines a second channel extending therethrough, the second channel being in fluid communication with the first channel; and
a mixing element coupled to the first interior surface and extending into the first channel.

2. The adapter of claim 1, wherein the mixing element is integrally formed with the neck section.

3. The adapter of claim 2, wherein the neck section, the cap section, and the mixing element form a single integrally formed assembly.

4. The adapter of claim 1, wherein the cap section includes a position indicator integrally molded thereon, the position indicator configured to align the adapter with the fluid container.

5. The adapter of claim 1, wherein the mixing element comprises at least one of a center of flow redirect mixer, a spiral mixer, a multiflux mixer, an x-mixer, and an inversion mixer.

6. The adapter of claim 1, wherein the adapter comprises a single component adapter body.

7. A mixing assembly configured to couple to a container, the mixing assembly comprising:
an adapter comprising:
a neck section having an exterior surface and a neck interior surface, the exterior surface defining a first attachment portion, the neck interior surface defining a neck channel extending therethrough;
a cap section extending from the neck section, the cap section having a cap interior surface that defines a cap channel extending therethrough, the cap channel being in fluid communication with the neck channel; and
a mixing element coupled to the neck interior surface and extending into the neck channel; and
a nozzle including a second attachment portion configured to engage with the first attachment portion of the neck section to secure the nozzle to the adapter.

8. The mixing assembly of claim 7, wherein the mixing element is a first mixing element, and wherein the nozzle has a nozzle interior surface that defines a nozzle channel extending therethrough, the nozzle further comprising:
a second mixing element coupled to the nozzle interior surface and extending into the nozzle channel.

9. The mixing assembly of claim 7, wherein the mixing element is integrally formed with the neck section.

10. The mixing assembly of claim 7, wherein the cap section includes a position indicator integrally molded thereon, the position indicator configured to align the adapter with the container.

11. The mixing assembly of claim 7, wherein the mixing element comprises at least one of a center of flow redirect mixer, a spiral mixer, a multiflux mixer, an x-mixer, and an inversion mixer.

12. The adapter of claim 7, wherein nozzle comprises a caulk cone.

13. A dispenser, comprising:
a fluid container;
an adapter configured to couple to the fluid container, the adapter comprising:
a neck section having an exterior surface and a neck interior surface, the neck interior surface defines a neck channel extending therethrough;
a cap section coupled to the neck section, the cap section having a cap interior surface that defines a cap channel extending therethrough, the cap channel being in fluid communication with the neck channel; and
a mixing element coupled to the neck interior surface and extending into the neck channel; and
a nozzle configured to engage with the neck section.

14. The dispenser of claim 13, further comprising:
a collapsible container configured to contain two fluids, the collapsible container being sized to be positioned within the fluid container.

15. The dispenser of claim 14, further comprising:
a plunger assembly having a single plunger configured to slide within the fluid container to dispense the two fluids contained within the collapsible container.

16. The dispenser of claim 13, wherein the mixing element is a first mixing element, and wherein the nozzle has a nozzle interior surface that defines a nozzle channel extending therethrough, the nozzle further comprising:
a second mixing element coupled to the nozzle interior surface and extending into the nozzle channel.

17. The dispenser of claim 13, wherein the mixing element is integrally formed with the neck section.

18. The dispenser of claim 13, wherein the cap section includes a position indicator integrally molded thereon, the position indicator configured to align the adapter with the fluid container.

19. The dispenser of claim 13, wherein the mixing element comprises at least one of a center of flow redirect mixer, a spiral mixer, a multiflux mixer, an x-mixer, and an inversion mixer.

20. The dispenser of claim 13, further comprising a nut configured to secure the adapter to the fluid container.
